(19) United States
(12) Patent Application Publication
(10) Pub. No.: US 2003/0002389 A1
(43) Pub. Date: Jan. 2, 2003

(54) Timekeeping device

(76) Inventor: Jessica Chang, Taipei (TW)

Correspondence Address: RABIN & CHAMPAGNE, PC, 1101 14TH STREET, NW, SUITE 500, WASHINGTON, DC, 20005, US

(21) Appl. No.: 09/892,738

(22) Filed: Jun. 28, 2001

(51) Int. Cl. G04B 47/00

(52) U.S. Cl. 368/10

(57) ABSTRACT

A timekeeping device of the present invention comprises an input unit connected to a computer peripheral interface and a timekeeper disposed on the input unit. The timekeeper has a timekeeping circuit connected to a voice part, a light emitting part, an LCD, and switches for starting timekeeping, setting time, or resetting time. When a computer is not in use, a user of the mouse can set use time on the timekeeper. When the computer is turned on for use, the switches can be pressed to start timekeeping. Once the set time has arrived, the timekeeping circuit will drive the voice part to give out sound or drive the light emitting part to give out light, hence informing the user the time of operating the computer. The present invention can also automatically turn on or off a computer once the set time has arrived.

### FIELD OF THE INVENTION

The present invention relates to a timekeeping device and, more particularly, to a device capable of informing a user the time of operating a computer and setting the time of turning on or off a computer.

### BACKGROUND OF THE INVENTION

A mouse is a peripheral input unit of computer. It can control the movement and scroll of a frame on a computer screen, and is a prerequisite equipment of a general computer user. In other words, the use of a mouse is very frequent so that a computer user usually does not know the use time of mouse.

There are program icons having time function to be directly selected on a computer screen. However, they cannot let parents know the use time of their children on a computer.

Situations such as not smooth circulation of blood of computer users due to longtime operation without appropriately stretching their bodies have occurred, usually causing deterioration of eyesight and even hazards such as strokes.

Accordingly, the present invention aims to propose a timekeeping device capable of directly informing a user the time of operating a computer on an input unit.

### SUMMARY OF THE INVENTION

One object of the present invention is to provide a device capable of directly informing a user the time of operating a computer, wherein a timekeeper is disposed on an input unit connected with a computer peripheral interface. The timekeeper has a timekeeping circuit, which is connected to a voice part, a light emitting part, and a liquid crystal display (LCD). The LCD is connected with a control circuit in the input unit. A user can thus be informed of the time of operating a computer.

Another object of the present invention is to provide a device capable of letting parents monitor their children the time of using a computer.

Yet another object of the present invention is to provide a timekeeping device capable of automatically turning on of off a computer when the set time has arrived, hence preventing deterioration of eyesight and not smooth circulation of blood for a longtime computer user.

The various objects and advantages of the present invention will be more readily understood from the following detailed description when read in conjunction with the appended drawing, in which:

### BRIEF DESCRIPTION OF THE DRAWINGS

FIG. 1 is a perspective view of the present invention;

FIG. 2 is a diagram showing the circuit architecture of the present invention;

FIG. 3 is a circuit diagram of the present invention; and

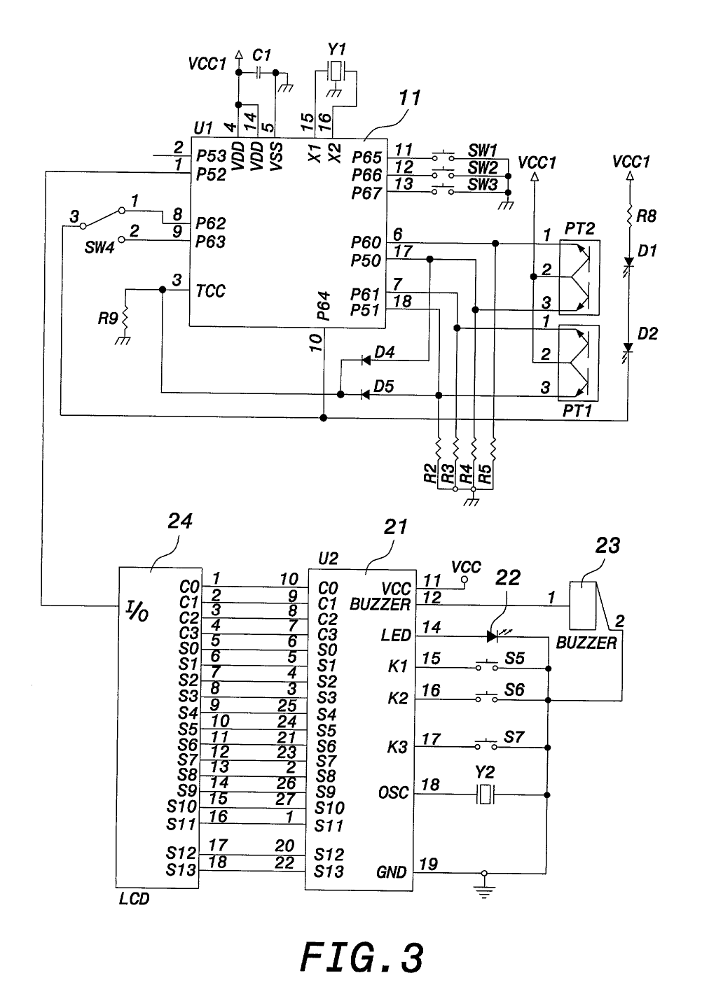

FIG. 4 is a control flowchart of the present invention.

### DETAILED DESCRIPTION OF THE PREFERRED EMBODIMENTS

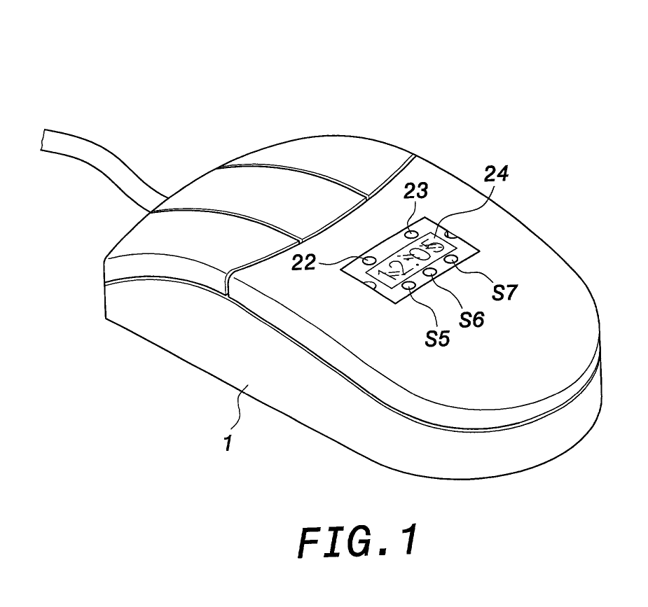

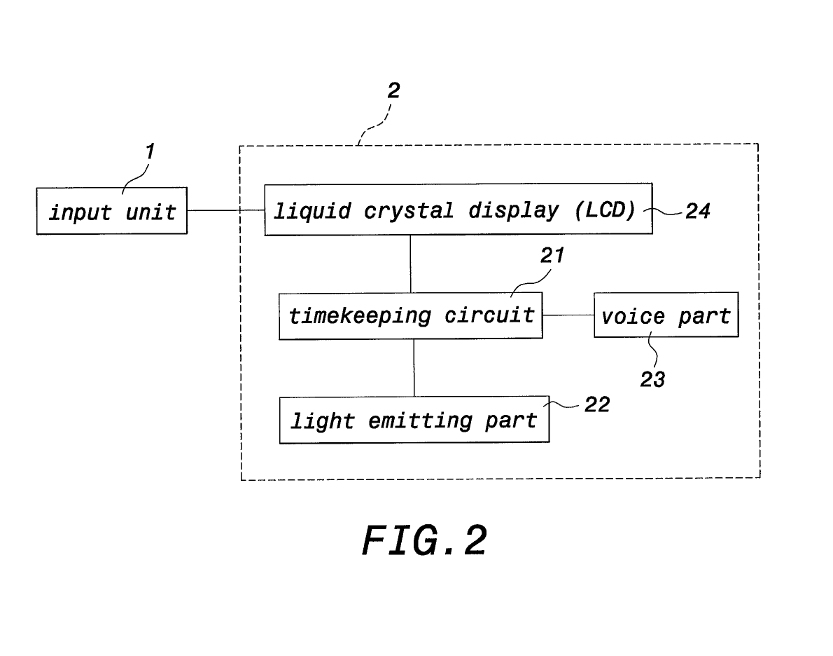

As shown in FIGS. 1 to 2, a timekeeping device of the present invention comprises an input unit 1 and a timekeeper 2.

The input unit 1 is connected with a computer peripheral interface (not shown) such as a universal serial bus (USB) or a personal system/2 (PS/2) interface. The input unit 1 can be a mouse, a track ball, or a keyboard. In the embodiment of the present invention, the input unit 1 is a mouse.

The mouse 1 has a control circuit 11 composed of a micro controller U1, a quartz crystal Y1, two diodes D4 and D5, two light emitting diodes D1 and D2, two phototransistors PT1 and PT2, switches SW1˜4, a capacitor C1, and resistors R2˜R5. The micro controller U1 performs relevant functions such as controlling the scroll of screen according to the states of the switches SW1˜4.

The timekeeper 2 is disposed on the mouse 1. The timekeeper 2 has a timekeeping circuit 21 formed by connecting a driver U2, a quartz crystal Y2, and switches S5˜S7. The timekeeping circuit 21 is connected to a light emitting part 22, a voice part 23, and an LCD 24. The LCD 24 is connected with an I/O pin (P52) of the micro controller U1 of the control circuit 11. The switches S5˜7 are used to set time, start timekeeping, or reset time. The light emitting part 22 or the voice part 23 gives out light or sound to inform or alarm a user once the set time has arrived.

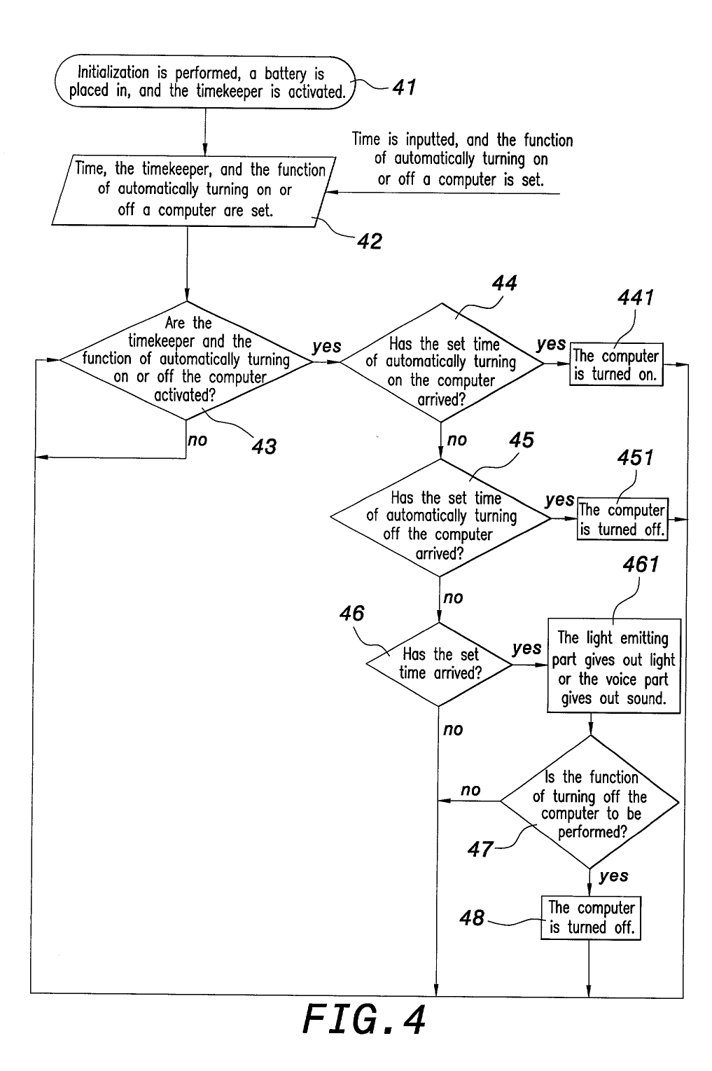

FIG. 4 is a control flowchart of the present invention. First, initialization is performed, a battery is placed in, and the timekeeper is activated (41). Time, the timekeeper, and the function of automatically turning on or off are set (42). Next, whether the timekeeper and the function of automatically turning on or off are activated is judged (43).

If the answer is negative, the step 43 is jumped back to; otherwise, whether the set time of automatically turning on a computer has arrived is judged (44).

If the answer is positive, the computer is turned on (441) and the step 43 is jumped back to; otherwise, whether the set time of automatically turning off the computer has arrived is judged (45).

If the answer is positive, the computer is turned off (451) and the step 43 is jumped back to; otherwise, whether the set time of starting timekeeping has arrived is judged (46).

If the answer is negative, the step 43 is jumped back to; otherwise, the light emitting part gives out light or the voice part gives out sound (461), and whether the function of turning off the computer is to be performed is judged (47).

If the answer is negative, the step 43 is jumped back to; otherwise, the computer is turned off (48), and the step 43 is jumped back to.

When a computer is not in use, a user of the mouse can set use time on the timekeeper 2. When the computer is turned on for use, the timekeeping switch S5 can be pressed to start timekeeping. Once the set time has arrived, the timekeeping circuit 21 will drive the voice part 23 to give out sound or drive the light emitting part 22 to give out light, hence informing the user the time of operating the computer. Simultaneously, the present invention can also automatically turning on or off a computer through the control circuit 11 of the mouse 1 once the set time has arrived.

To sum up, the present invention can set the time of turning on or off a computer, can inform or alarm a user the time of operating a computer, and can let parents monitor their children the time of using a computer, thereby avoiding occurrence of incidents.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A timekeeping device comprising:
an input unit connected to a computer peripheral interface and having a control circuit therein to perform relevant functions; and
a timekeeper disposed on said input unit, said timekeeper having a timekeeping circuit connected to said control circuit, said timekeeping circuit being connected to an alarming unit, a display unit, and switches for starting timekeeping, setting time, or resetting time, said display unit being connected to said control circuit;
whereby a user can be informed of the time of operating a computer, or a computer can be automatically turned on or off.

2. The timekeeping device as claimed in claim 1, wherein said input unit can be a mouse, a track ball, or a keyboard.

3. The timekeeping device as claimed in claim 1, wherein said control circuit has a micro controller therein whose I/O pin is connected to said display unit.

4. The timekeeping device as claimed in claim 1, wherein said alarm unit can be a voice part or a light emitting part.
